(19) United States
(12) Patent Application Publication
(10) Pub. No.: US 2026/0009288 A1
(43) Pub. Date: Jan. 8, 2026

(54) CHILD PROOF GATE EMPLOYING A DOUBLE ACTUATING MECHANISM

(71) Applicant: Baby Trend, Inc., Fontana, CA (US)

(72) Inventors: John W. Riedl, Rancho Cucamonga, CA (US); Michael T. Cavins, San Bernardino, CA (US); Matthew R. Benich, Ontario (CA); Michael F. Norris, Rancho Cucamonga, CA (US)

(21) Appl. No.: 19/260,354

(22) Filed: Jul. 4, 2025

Related U.S. Application Data
(60) Provisional application No. 63/667,928, filed on Jul. 5, 2024.

(51) Int. Cl. E06B 9/04; E05B 65/00; E06B 9/00

(52) U.S. Cl. CPC E06B 9/04; E05B 65/0014; E06B 2009/002

(57) ABSTRACT

A child proof gate includes a U-shaped frame configured to be pressure fit between two opposing flat surfaces, wherein the frame comprises a first locking assembly, a second locking assembly, and a button that is configured to be manually; wherein the manually activated button is disposed apart from and above the first locking assembly and wherein the button, when manually activated, is configured to electrically actuate the first locking assembly and to move the first locking assembly from a closed position to an open position for a predetermined period of time. The gate may also include a door including an upper mating door latch and a lower mating door latch; wherein the upper mating door latch is configured to be removably attached to the first locking assembly when the door is in a closed position.

### RELATED APPLICATIONS

This application claims priority to U.S. Provisional Application No. 63/667,928, filed July 5, 2024, and entitled Child Proof Gate Employing a Double Actuating Mechanism, the entirety of which is hereby incorporated by reference.

### TECHNICAL FIELD

The disclosure relates to a child proof gate that is configured to be opened without the use of the user's hands. Specifically, the disclosure relates to a double-actuated child proof gate that is operable without the use of a user's hands.

### BACKGROUND

Typically, child proof gates may be used to block passage of a child or other person from one room to another or from entering and exiting a stairway. In one known embodiment, child proof gates may employ a combination of foot pedals and/or electronic sensors to open the door of the gate. However, even with the double actuated gate, it is possible that the electronic sensor may be triggered on accident, when a user comes too close to the sensor. This may allow the gate to be inadvertently opened. It would be beneficial if the second mechanism for opening the door to the gate could not be accidentally activated by a child or other user in close proximity to the gate frame.

### SUMMARY

In one embodiment, a child proof gate includes a U-shaped frame configured to be pressure fit between two opposing flat surfaces, wherein the frame comprises a first locking assembly, a second locking assembly, and a button that is configured to be manually or voice activated; wherein the button is disposed apart from and above the first locking assembly and wherein the button, when activated, is configured to electrically actuate the first locking assembly and to move the first locking assembly from a closed position to an open position for a predetermined period of time. The gate may also include a door including an upper mating door latch and a lower mating door latch; wherein the upper mating door latch is configured to be removably attached to the first locking assembly when the gate is in a closed position.

### BRIEF DESCRIPTION OF THE DRAWINGS

FIG. 1 is a front perspective view of one embodiment of a child proof gate.

FIG. 2 is an exploded detail view of the first locking assembly of the child proof gate in a locked position.

FIG. 3 is an exploded detail view of the first locking assembly of the child proof gate in an unlocked position.

FIG. 4 is a cross sectional view of the first locking assembly of the child proof gate in a locked position.

FIG. 5 is a detail perspective view of the first locking assembly and the mating door assembly of the child proof gate in an open position.

FIG. 6 is a detail perspective view of the first locking assembly and the mating door assembly of the child proof gate in a closed position.

FIGS. 7 and 8 are detail perspective views of a self-closing hinge in a closed and open position, respectively.

FIG. 9 is a detail perspective view of a second locking assembly and mating door latch in a locked position.

FIG. 10 is a detail perspective view of the second locking assembly and mating door latch in an unlocked, or depressed, position.

FIG. 11 is a cross sectional view of the second locking assembly and mating door latch in an unlocked, or depressed, position.

FIG. 12 is detail perspective view of the second locking assembly and mating door latch in an open position.

FIG. 13 is detail perspective view of the second locking assembly and mating door latch as the latch closes over the ramp of the second locking assembly.

### DETAILED DESCRIPTION

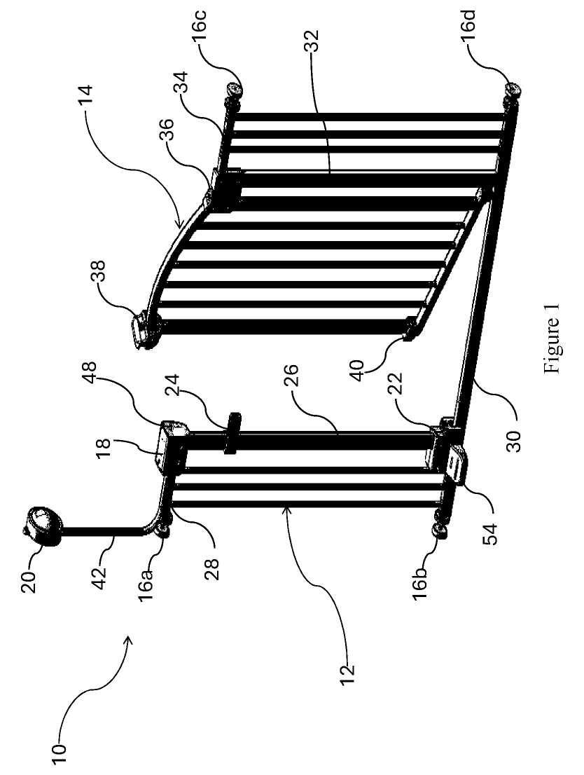

As shown in FIG. 1, a child proof gate 10 includes a U-shaped frame 12 and self- closing door 14. In one embodiment, the frame 12 may include a set of four dial assemblies 16a, b, c, and d, positioned around the frame 12 and configured to pressure fit the frame 12 against opposing flat surfaces, such as a door frame or opposing walls (not shown). By rotating the dial in a first direction, a plunger is moved in and out in order to secure the gate 10 between opposing surfaces. It should be appreciated that any suitable attachment mechanism may be used to adhere the frame 12 of the gate 10 to the opposing surfaces.

The frame 12 also includes a first locking assembly 18 disposed at a first top portion 28 of the frame 12, a manually or voice activated button 20 spaced apart from and above the first locking assembly 18, and a second locking assembly 22 disposed at the base 30 of the frame 12. The frame 12 may also include an optional swing direction limiter 24 configured to prevent the door 14 from swinging in a certain direction. In one embodiment, the direction limiter 24 is removably attached to a first frame support 26, which extends between the first top portion 28 and the base 30 of the frame 12. The frame 12 may also include a second frame support 32 extending between a second top portion 34 and the base 30.

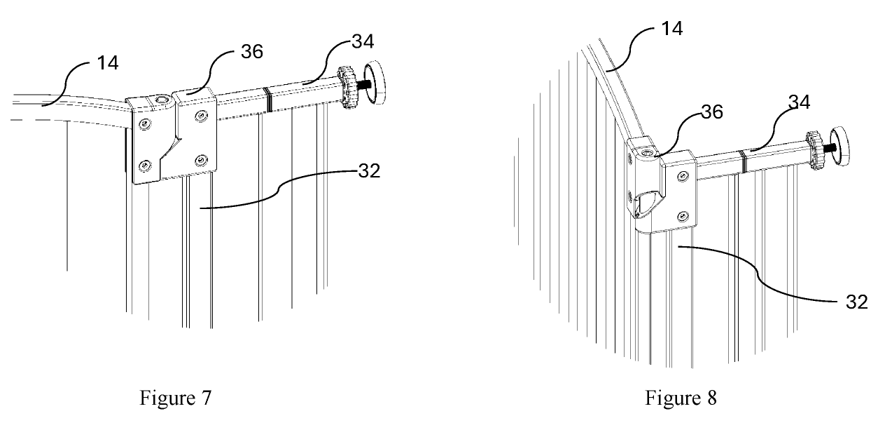

The door 14 is configured to attach to the second frame support 32 at upper and lower attachment points. In one embodiment, as shown in FIGS. 1, 7, and 8, the door 14 may be connected at an upper attachment point to the second frame support 32 and the second top portion 34 of the frame 12 with a self-closing hinge 36. The self-closing hinge 36 may be any suitable hinging mechanism. One example of a suitable self-closing hinge 36 is shown in closed and open positions in FIGS. 7 and 8, respectively. In this embodiment, once the door 14 is unlocked and pushed open by the user, it will return to a closed position without the user needing to push the door 14 closed.

Referring again to FIG. 1, the door 14 may also include two mating door latches 38 and 40 that are configured to mate with and attach to the first and second latching assemblies 18 and 22, respectively. In one embodiment, the first latching assembly 18 is actuated when a user presses the button 20 with, for example, their shoulder or elbow (if their hands are full). In this embodiment, the button 20 is disposed apart from and, desirably, above the first latching assembly 18, such that it may not be inadvertently pushed or released by a small child. In one embodiment, the button 20 may be positioned against a first opposing flat surface (not shown). It may be configured to be attached to the flat surface or rest against the surface for support. The button 20 may be any suitable button configuration.

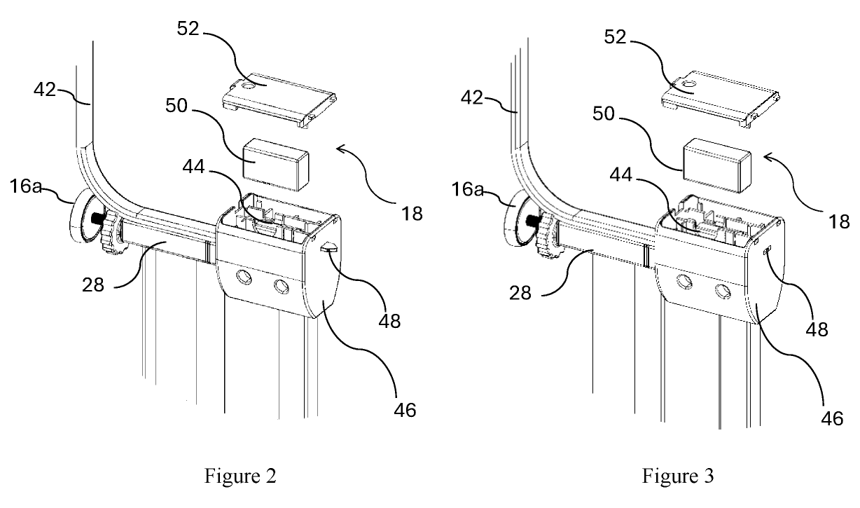

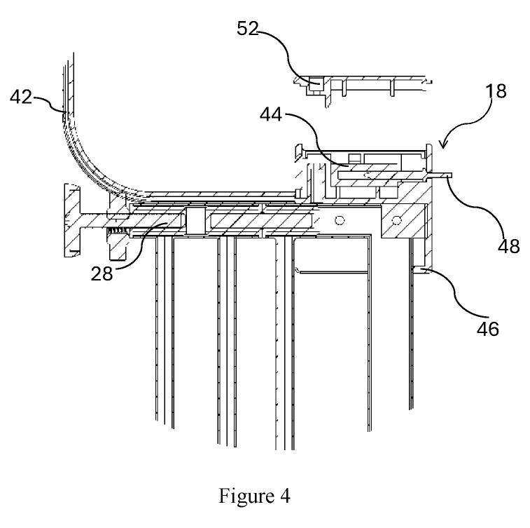

In one example, the button 20 is supported by an arm 42 connected to the first top portion 28 of the frame 12. The arm 42 may include the necessary electrical connections (either hard wired or wireless) to communicate with, for example, a solenoid valve 44 disposed in a housing 46 of the first locking assembly 18 (FIGS. 2, 3, and 4). Once the button 20 is pushed, the gate 10 is configured to send a signal to the first locking assembly 18 to retract a pin 48 for a predetermined period of time. In one embodiment, the pin 48 is configured to be retracted for a period of five seconds upon activation by the button 20 (as shown in FIG. 3).

Referring now to FIGS. 2, 3, and 4 the first locking assembly 18 may be battery 50 powered. The batter 50 and solenoid valve 44 may be disposed within the housing 46 and encased within the housing 46 with a removable cover 52. The battery 50 may be any suitable battery or combination of batteries, such as a 9V, AA, AAA, etc.

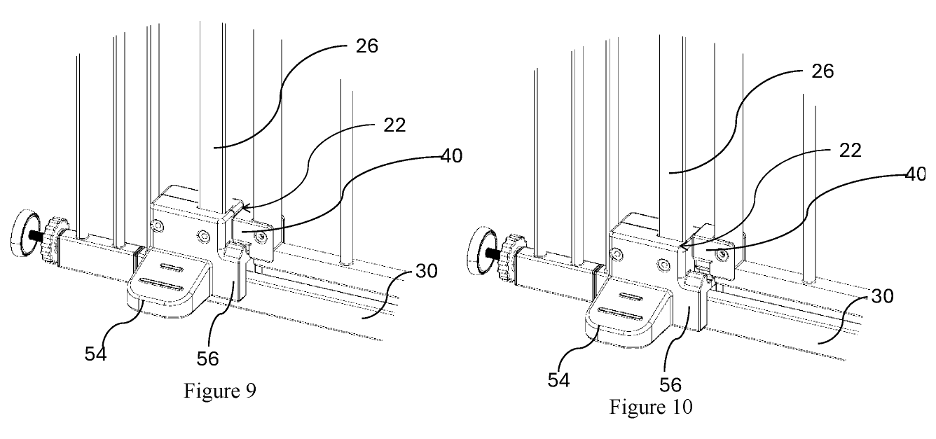

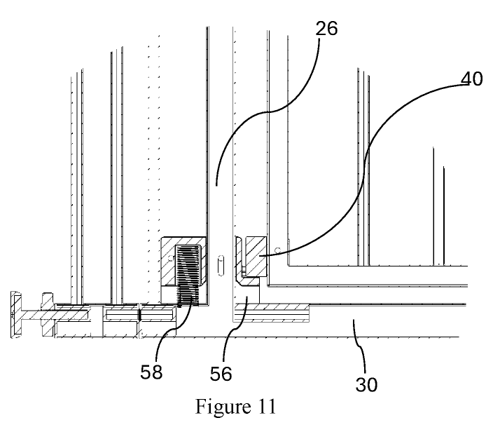

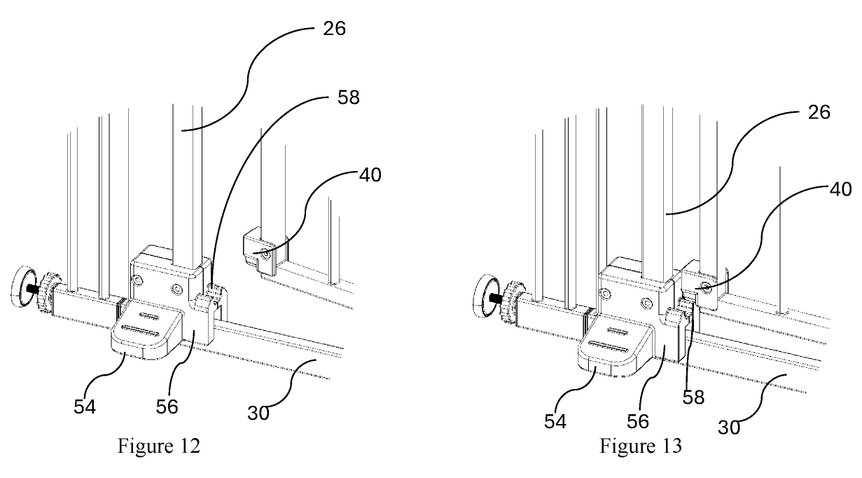

Once the button 20 is depressed by the user's shoulder, for example, and the first locking assembly 18 retracts the pin 48, the user then depresses a foot pedal 54 to open the second locking assembly 22 (FIGS. 1, 9-13). As shown in FIGS. 1 and 9-13, the second locking assembly 22 is connected to the frame 12 where the base 30 and the first frame support 26 meet. In one embodiment, the second locking assembly 22 is a spring biased mechanism (as shown in FIG. 11), which is configured to move a carriage 56 of the second locking assembly 22 from a first (closed) position to a second (open) position when the pedal 54 is depressed. As shown in FIGS. 10 and 11, when the pedal 54 is depressed, a spring 58 is compressed, which forces the carriage 56 to move toward the base 30.

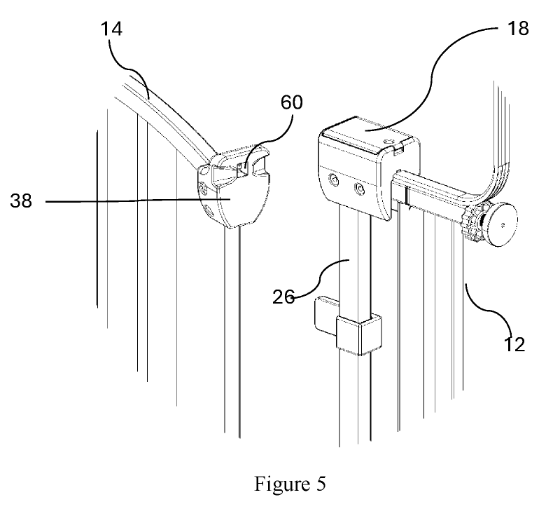

As the carriage 56 moves down in response to the depression of the pedal 54, the lower mating door latch 40 disposed toward the bottom of the door 14 is released from a catch 58 in the carriage 56. Ideally, this will occur within the five seconds (for example) that the pin 48 in the first locking assembly 18 is retracted, and thereby released from a recess 60 in the upper mating door latch 38 (FIG. 5), allowing the door 14 to move freely from the frame 12. As described above, the door 14 may then close behind the user and will automatically lock into place as the pin 48 in the first locking assembly 18 extends and snap fits within the recess 60 of the upper mating door latch 38 and the lower mating door latch 40 travels over a sloped edge of the catch 58 (FIG. 13) and is secured therein.

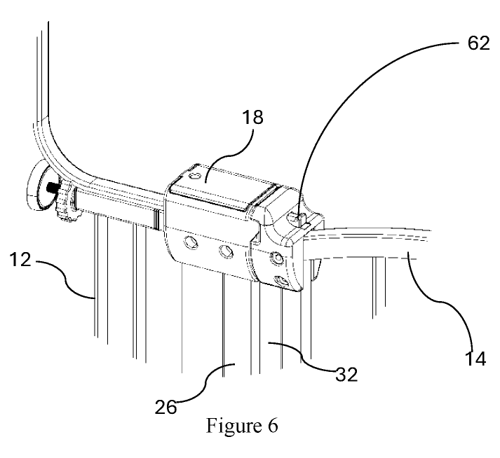

Referring now to FIG. 6, in one embodiment, the upper mating door latch 38 may also include a manual release mechanism 62, which allows a user to manually retract the pin 48 (not shown), if necessary, while depressing the pedal 54 to open the door 14.

This written description sets forth the best mode of carrying out the invention and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

What is claimed is:

1. A child proof gate comprising:
a U-shaped frame configured to be pressure fit between two opposing flat surfaces, wherein the frame comprises a first locking assembly, a second locking assembly, and a button that is configured to be manually or voice activated;
wherein the button is disposed apart from and above the first locking assembly and wherein the button, when activated, is configured to electrically actuate the first locking assembly and to move the first locking assembly from a closed position to an open position for a predetermined period of time;
a door comprising an upper mating door latch and a lower mating door latch; wherein the upper mating door latch is configured to be removably attached to the first locking assembly when the door is in a closed position.

2. The child proof gate of claim 1, wherein the second locking assembly comprises a foot pedal and a carriage, wherein the foot pedal is configured to move the carriage from a closed position to an open position when the pedal is depressed.

3. The child proof gate of claim 2, wherein the second locking assembly is spring actuated.

4. The child proof gate of claim 2, wherein the lower mating door latch is configured to be removably attached to the second locking assembly when the carriage is in a closed position.

5. The child proof gate of claim 1, wherein the button is configured to be manually activated.

6. The child proof gate of claim 1, wherein the button is attached to and above the frame with an adjustable arm.

7. The child proof gate of claim 1, wherein the first locking assembly comprises a retractable pin that is configured to be electrically retracted by the manual activation of the button.

8. The child proof gate of claim 1, wherein the frame further comprises a swing direction limiter configured to restrict movement of the door in a certain direction.

9. A child proof gate comprising:
a U-shaped frame configured to be pressure fit between two opposing flat surfaces, wherein the frame comprises a first locking assembly, a second locking assembly, and a button that is configured to be manually or voice activated;
wherein the button is disposed apart from and above the first locking assembly and wherein the button, when activated, is configured to electrically actuate the first locking assembly and to move the first locking assembly from a closed position to an open position for a predetermined period of time; and
wherein the second locking assembly comprises a foot pedal and a carriage, wherein the foot pedal is configured to move the carriage from a closed position to an open position when the pedal is depressed; and
a door comprising an upper mating door latch and a lower mating door latch; wherein the upper mating door latch is configured to be removably attached to the first locking assembly when the door is in a closed position.

10. The child proof gate of claim 9, wherein the button is configured to be manually activated.

11. The child proof gate of claim 9, wherein the second locking assembly is spring actuated.

12. The child proof gate of claim 9, wherein the lower mating door latch is configured to be removably attached to the second locking assembly when the carriage is in a closed position.

13. The child proof gate of claim 9, wherein the button is attached to and above the frame with an adjustable arm.

14. The child proof gate of claim 9, wherein the first locking assembly comprises a retractable pin that is configured to be electrically retracted by the manual activation of the button.

15. The child proof gate of claim 9, wherein the frame further comprises a swing direction limiter configured to restrict movement of the door in a certain direction.
